(19) United States
(12) Patent Application Publication
(10) Pub. No.: US 2018/0253889 A1
(43) Pub. Date: Sep. 6, 2018

(54) INFORMATION PROCESSING APPARATUS, STORAGE MEDIUM, AND INFORMATION PROCESSING METHOD FOR PROCESSING CLIPPING RENDERING INSTRUCTION

(71) Applicant: CANON KABUSHIKI KAISHA, Tokyo (JP)

(72) Inventor: Hitoshi Nagasaka, Kashiwa-shi (JP)

(21) Appl. No.: 15/905,564

(22) Filed: Feb. 26, 2018

(30) Foreign Application Priority Data
Mar. 6, 2017 (JP) 2017-042044

(51) Int. Cl. G06T 15/30

(52) U.S. Cl. CPC G06T 15/30

(57) ABSTRACT

The apparatus specifies a circumscribed rectangular area of each attribute with respect to a clipping rendering instruction using a rendering bitmap and a mask bitmap of each attribute, cuts out a partial rendering bitmap of each attribute and a partial mask bitmap of each attribute corresponding to the circumscribed rectangular area from the rendering bitmap and the mask bitmap, and replaces the rendering bitmap and the mask bitmap used for the clipping rendering instruction with the cutout partial rendering bitmap and the cutout partial mask bitmap.

### BACKGROUND OF THE INVENTION

### Field of the Invention

An aspect of the embodiments relates to processing of a clipping rendering instruction.

### Description of the Related Art

At present, although there are various types of page description language (PDL), “clipping rendering instruction” is a rendering instruction generally used in the PDL of any type. In many cases, the clipping rendering instruction is used for rendering graphics or characters in complex colors. For example, the clipping rendering instruction is used when a gradation image composed of complex colors is clipped and rendered with a shape of a graphic or a character.

The clipping rendering can be realized with various rendering instructions. For example, the clipping rendering can be realized through a method using a Mask rendering instruction described in high-level language or a method using a combination of logical operation rendering instructions described in low-level language. As a method of realizing the clipping rendering by combining logical operation rendering instructions described in low-level language, there is provided a method of sequentially applying an XOR rendering instruction, an AND rendering instruction, and the XOR rendering instruction in the order (hereinafter, referred to as “XAX method”). In order to enable an apparatus which does not support the mask rendering instruction to execute the processing, the above described method of realizing the clipping rendering by combining logical operation rendering instructions described in low-level language is frequently used. Specific examples are illustrated in FIGS. 1A and 1B.

FIG. 1A is a diagram illustrating a method of realizing the clipping rendering by using a mask rendering instruction. In this method, a clipping target image (e.g., gradation image) is rendered by an image rendering instruction, and the mask rendering instruction is executed by using a mask bitmap image illustrating positions of pixels to be clipped out, so that a clipping rendering result can be acquired. Black pixels of the mask bitmap image represent positions of pixels to be clipped out from the clipping target image.

FIG. 1B is a diagram illustrating an example of the clipping rendering realized by the XAX method, and a rendering result will be similar to the result acquired in FIG. 1A. In the XAX method, with respect to a memory area where rendering is executed, an XOR rendering instruction is executed by using a clipping target image (e.g., gradation image). Then, an AND rendering instruction is executed by using a mask bitmap image illustrating positions of pixels to be clipped out. Further, an XOR rendering instruction is executed by using a clipping target image (e.g., gradation image), so that a clipped rendered image can be acquired. In addition, the XOR rendering instruction and the AND rendering instruction are arithmetic processing to be executed on an image that has already been rendered. Black pixels of the mask bitmap image in FIG. 1B represents positions of pixels to be clipped out from the clipping target image (e.g., gradation image), and white pixels of the mask bitmap image in FIG. 1B represents positions of pixels whose values of the pixels rendered before executing clipping rendering are maintained. The pixel value of the black pixel in the mask bitmap image is “1”, and the pixel value of the white pixel in the mask bitmap image is “0”.

Further, when printing output is to be executed, an image forming apparatus such as a digital copying machine or a printer executes image processing appropriate for respective attributes of an image, text, and a graphic is executed with respect to an image portion or a graphic portion in the input information to improve printing quality. For example, image processing according to respective attributes is executed through the following procedure. First, a printer driver determines information about “rendering attribute” of a rendering instruction based on a type of the rendering instruction input through an application. Specifically, the printer driver determines that the rendering attribute is an image attribute if the rendering instruction is rendering of an image, and determines that the rendering attribute is a text attribute if the rendering instruction is rendering of a character. Further, the printer driver determines that the rendering attribute is a graphic attribute if the rendering instruction is rendering of a monochromatic graphic, and determines that the rendering attribute is a line attribute if the rendering instruction is rendering of a line. Then, the printer driver converts the rendering instruction to a PDL rendering command and transmits the PDL rendering command to the image forming apparatus together with the information about the determined rendering attribution to execute printing. In addition, information about a rendering attribute of one type can be attached to one rendering command. Further, with respect to a rendering command that cannot be processed by the image forming apparatus, the printer driver executes rendering (i.e., partial imaging) of a rectangular area including the rendering command to generate a bitmap and transmits the bitmap to the image forming apparatus. At this time, if the printer driver generates a single bitmap by rendering of a plurality of rendering instructions having different rendering attributes and transmits the bitmap as a single rendering command, a plurality of rendering instructions originally having different rendering attributes is included in the single bitmap, and thus the image forming apparatus cannot execute image processing appropriate for the respective rendering attributes. In such a case, the printer driver generates a rendering bitmap (combined bitmap) illustrating the rendering content and an attribute bitmap illustrating an attribute at each pixel of the rendering bitmap. Then, the printer driver converts these bitmaps into a PDL rendering command and transmits the PDL rendering command to the image forming apparatus to execute printing, so that the image forming apparatus can switch and execute image processing appropriate for each rendering attribute in a pixel unit with respect to the rendering bitmap in which the plurality of attributes exists. United States Patent Application Publication No. 2014/0376055 A1 discusses a technique to which the above-described clipping rendering is applied in order to execute image processing appropriate for each rendering attribute with respect to a rendering bitmap in which a plurality of rendering attributes exists. By using the above-described method, even if partial imaging is executed (a part of the rendering command is processed into a rendering bitmap by the printer driver), image processing (color processing) appropriate for the original attribute can be executed. A specific example of the technique described in United States Patent Application Publication No. 2014/0376055 A1 will be described with reference to FIGS. 2 and 3. In FIG. 2, instructions such as a graphic rendering 202, a text rendering 203, and an image rendering 204 are included in a document 201. In the document 201, if the graphic rendering 202 is a gradation rendering instruction that cannot be processed by the image forming apparatus, a rectangular area that surrounds the graphic rendering 202 is regarded as a partial imaging target (i.e., bitmapping target). A rendering bitmap 205 in FIG. 2 is an enlarged view of the rectangular area as a bitmapping target, and the rendering bitmap 205 is generated based on the rendering instruction included in the rectangular area. At this time, attribute bitmaps illustrating attributes of respective pixels corresponding to the rendering bitmap 205 are also generated. FIGS. 3G, 3I, and 3T are diagrams illustrating an overview of processing of clipping the rendering bitmap 205 in FIG. 2 at each attribute through the XAX method. First, based on the attribute bitmaps, mask bitmaps of respective attributes, i.e., a graphic mask bitmap 302, an image mask bitmap 312, and a text mask bitmap 322, are created. In addition, the rendering bitmap 205 is used as a rendering bitmap 301, 303, 311, 313, 321, or 323 in FIGS. 3G, 3I, and 3T. In other words, in FIGS. 3G, 3I, and 3T, a rendering instruction group G illustrates processing of clipping out a rendering result 304 of the graphic attribute from the rendering bitmap 301, a rendering instruction group I illustrates processing of clipping out a rendering result 314 of the image attribute from the rendering bitmap 311, and a rendering instruction group T illustrates processing of clipping out a rendering result 324 of the text attribute from the rendering bitmap 321. For example, when the rendering result 304 of the graphic attribute is clipped, with respect to a memory area where rendering is to be executed, the XOR rendering instruction is executed by using the rendering bitmap 301. Then, the AND rendering instruction is executed by using the graphic mask bitmap 302, and the XOR rendering instruction is executed by using the rendering bitmap 303, so that a graphic portion can be clipped as the rendering result 304. Then, in FIGS. 3G, 3I, and 3T, a rendering attribute of the rendering command corresponding to the rendering instruction group G is taken as a graphic attribute, a rendering attribute of the rendering command corresponding to the rendering instruction group I is taken as an image attribute, and a rendering attribute of the rendering command corresponding to the rendering instruction group T is taken as a text attribute, so that image processing appropriate for respective attributes can be executed.

Executing clipping processing through a logical operation rendering instruction described in low-level language, of the XAX method is beneficial in that even a devise which only supports low-level language can execute the clipping processing. However, on the other hand, a size of the output PDL or time taken for the clipping rendering processing is likely to be increased. For example, in FIGS. 3G, 3I, and 3T, the XOR rendering instruction using the rendering bitmap 205 is issued for six times, and the AND rendering instruction using the mask bitmaps 302, 312, and 322 is issued for three times. Particularly, in a printing system using the internet such as a cloud printing system, an influence on communication time becomes greater if a size of the PDL is increased. In other words, if a size of the PDL is increased, communication time becomes longer, and thus time taken for printing is increased.

In particular, in the processing such as the XAX method in which a plurality of bitmaps are composited (composite processing of the XOR rendering instruction and the AND rendering instruction), time taken for the processing is increased if a bitmap area (i.e., an area as a partial imaging target) is wider.

### SUMMARY OF THE INVENTION

According to an aspect of the embodiments, an apparatus includes a specification unit configured to specify a circumscribed rectangular area of each attribute with respect to a clipping rendering instruction using a rendering bitmap and a mask bitmap of each attribute, and a cutout unit configured to cut out a partial rendering bitmap of each attribute and a partial mask bitmap of each attribute corresponding to the circumscribed rectangular area from the rendering bitmap and the mask bitmap, and to replace the rendering bitmap and the mask bitmap used for the clipping rendering instruction with the cutout partial rendering bitmap and the cutout partial mask bitmap.

Further features of the disclosure will become apparent from the following description of exemplary embodiments with reference to the attached drawings.

### BRIEF DESCRIPTION OF THE DRAWINGS

FIGS. 1A and 1B are diagrams respectively illustrating examples of clipping rendering executed through a mask rendering command and an XAX method.

FIG. 2 is a diagram illustrating an example of a partially imaged document.

FIGS. 3G, 3I, and 3T are diagrams illustrating examples in which clipping rendering is applied to a rendering bitmap 205 through an XAX method.

FIG. 4 is a block diagram illustrating a configuration of a printing system.

FIG. 5 is a block diagram illustrating an example of a software configuration of an information processing apparatus.

FIG. 6 is a flowchart illustrating processing content to be realized by a printer driver.

FIG. 7 is a flowchart illustrating a detail of clipping rendering optimization processing.

FIG. 8 is a flowchart illustrating a detail of a circumscribed rectangle extraction processing.

FIG. 9 is a diagram illustrating an example of cutting out a partial mask bitmap from a mask bitmap.

FIGS. 10G, 10I, and 10T are diagrams illustrating examples of a result acquired by applying the circumscribed rectangle extraction processing in FIG. 8 to the examples in FIGS. 3G, 3I, and 3T.

FIG. 11 is a flowchart illustrating a detail of image rendering instruction conversion processing.

FIGS. 12-1 and 12-2 are diagrams illustrating an example of replacing a single attribute clipping rendering instruction with an image rendering instruction.

FIGS. 13I, 13G, and 13T are diagrams illustrating an example of a result acquired by applying the image rendering instruction conversion processing in FIG. 11 to the examples in FIGS. 10G, 10I, and 10T.

FIG. 14 is a flowchart illustrating a detail of image rendering instruction conversion processing of a second exemplary embodiment.

FIGS. 15I, 15T and 15G are diagrams illustrating an example of a result acquired by further applying the processing in step S1405 to the example in FIGS. 13I, 13G and 13T.

### DESCRIPTION OF THE EMBODIMENTS

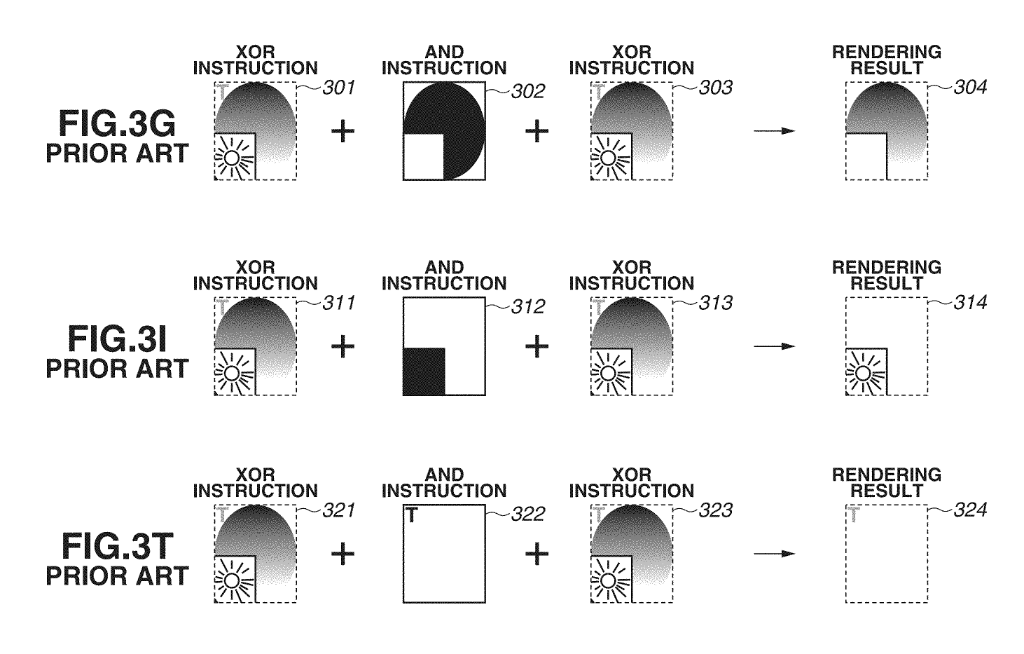

In a first exemplary embodiment, processing of executing clipping rendering of each rendering attribute through an XAX method illustrated in FIGS. 3G, 3I, and 3T will be described. Particularly, optimization processing for reducing a size of a rendering instruction, which is executed by a printer driver when the rendering instruction is converted into a clipping rendering instruction, will be described. In the below-described exemplary embodiment, “attribute” is used as a synonym with “rendering attribute”.

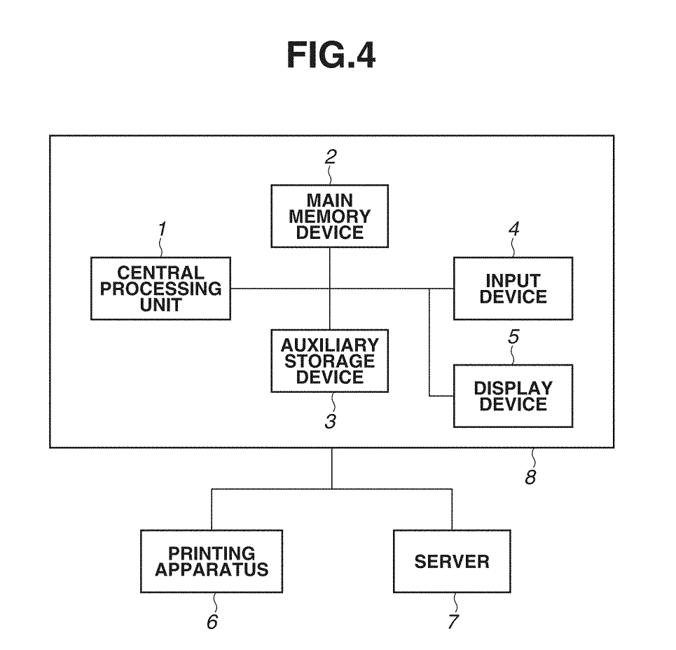

FIG. 4 is a diagram illustrating an example of a configuration of a printing system of the present exemplary embodiment. A printing apparatus 6, a printing server 7, and an information processing apparatus (client computer) 8 are connected to one another via a network. The information processing apparatus 8 is configured of a central processing unit (CPU) 1, a main storage device (random access memory (RAM)) 2, an auxiliary storage device 3, an input device 4, and a display device 5. The CPU 1 reads a program or relative data via a computer-readable storage medium (e.g., a compact disc read only memory (CD-ROM), a digital versatile disc read only memory (DVD-ROM), or a memory card) or a network, and stores the program or the relative data in the auxiliary storage device 3. The CPU 1 loads the program on the main storage device (RAM) 2 from the auxiliary storage device 3 and executes the program to function as respective processing units described in below-described flowcharts. The input device is configured of a keyboard or a pointing device. Further, the auxiliary storage device 3 is configured of a hard disk drive (HDD) or a solid state drive (SSD). A printing command to be transmitted from the information processing apparatus 8 may be transmitted to the printing apparatus 6 directly or via the printing server 7. In below-described exemplary embodiment, although description with respect to a configuration in which the print command is transmitted via the print server 7 will be omitted, it is not intended to exclude the configuration from the scope of the disclosure.

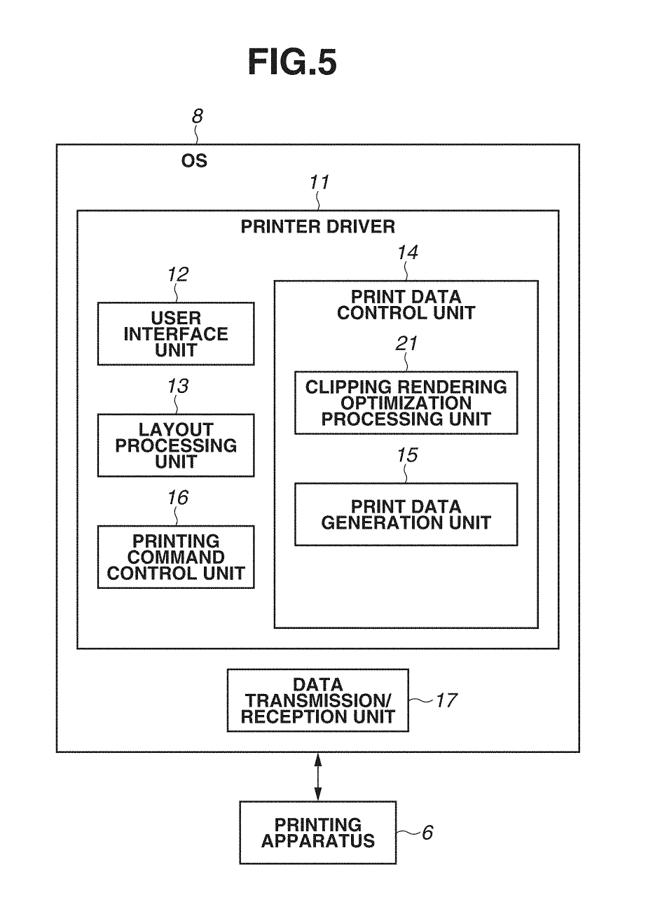

FIG. 5 is a conceptual diagram illustrating a software configuration for making the CPU 1 function as the below-described processing units when a program of the printer driver 11 for controlling the printing apparatus 6 is executed through an operating system (OS) of the information processing apparatus 8.

A user interface unit 12 provides a user interface for receiving the input of various printing settings used for printing or the input of a printing start instruction from a user.

A layout processing unit 13 receives a rendering instruction of printing specified by a document creation application and executes conversion according to a layout if a specification relating to a layout such as “N-up” (also called as “N-in-1”) is provided.

A print data control unit 14 receives a rendering instruction converted by the layout processing unit 13 and creates data that can be processed by the printing apparatus 6. The print data control unit 14 includes a clipping rendering optimization processing unit 21 and a print data generation unit 15, and realizes important processing to be executed by a host apparatus of the disclosure. The clipping rendering optimization processing unit 21 detects a clipping rendering instruction and converts the clipping rendering instruction into an optimum rendering instruction. The print data generation unit 15 generates a rendering command that can be processed by the printing apparatus 6, based on the rendering instruction transmitted from the clipping rendering optimization processing unit 21.

A printing command control unit 16 attaches auxiliary information to be used by the printing apparatus (e.g., information about a name of a print job, one-sided/two-sided printing, or a size of a medium) to the rendering command generated by the print data generation unit 15 to generate a print command. A data transmission/reception unit 17 is a function of the OS, which transmits a printing command to the printing apparatus 6 and receives various kinds of data from the printing apparatus 6.

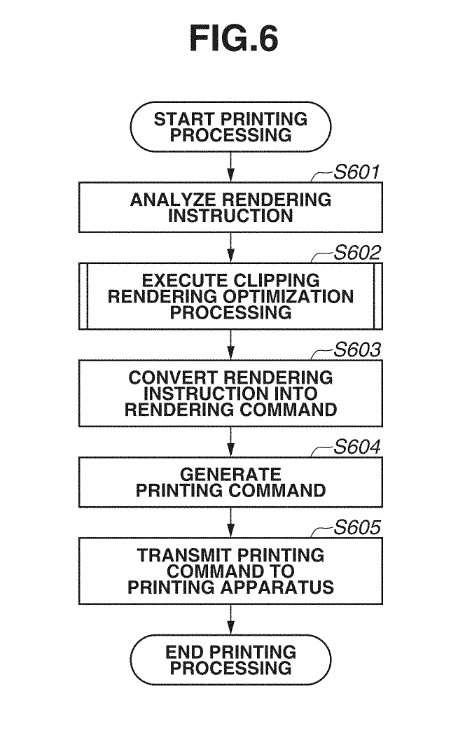

FIG. 6 is a flowchart illustrating processing to be executed by the information processing apparatus 8 when the information processing apparatus 8 executes a program of the printer driver 11. When the user inputs a printing instruction through a document creation application, a rendering instruction output from the document creation application is transmitted to the printer driver 11. Then, the processing illustrated in the flowchart is started.

In step S601, the layout processing unit 13 analyzes the rendering instruction received from the application, executes layout conversion as necessary, and transmits the rendering instruction to the print data control unit 14.

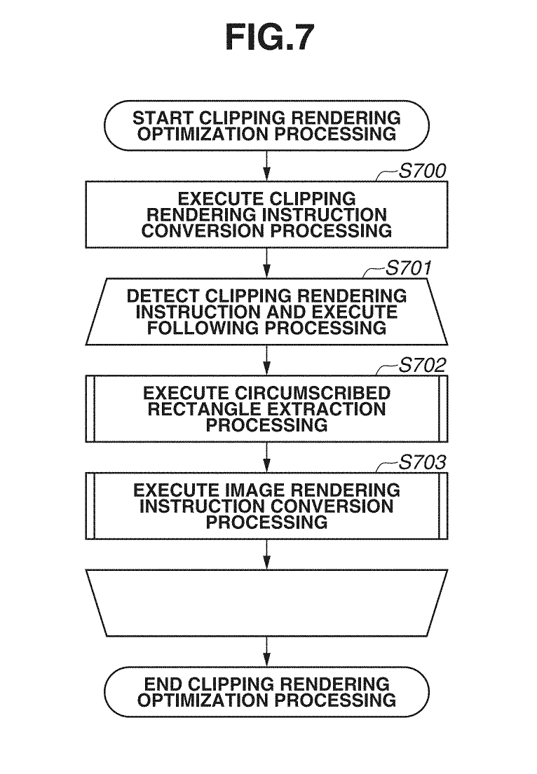

In step S602, the clipping rendering optimization processing unit 21 of the print data control unit 14 executes clipping rendering optimization processing to be described below with reference to FIG. 7.

In step S603, the print data generation unit 15 of the print data control unit 14 converts the rendering instruction on which the clipping rendering optimization processing unit 21 has executed the optimization processing, into a rendering command that can be received by the printing apparatus 6. Specifically, the rendering command refers to a PDL rendering command such as the post script (PS) (by Adobe Systems Co., Ltd.) or the printer control language (PCL) (by HP Inc.).

In step S604, the printing command control unit attaches auxiliary information to be used by the printing apparatus 6 (e.g., information about a name of a print job, one-sided/two-sided printing, or a size of a medium) to the rendering command generated by the print data generation unit 15 to generate a print command.

In step S605, the printing command control unit 16 transmits the printing command to the printing apparatus 6 via the data transmission/reception unit 17. Thereafter, the printing apparatus 6 executes rendering processing or half-tone processing based on the received printing command and executes printing on a sheet to complete printing processing.

FIG. 7 is a flowchart illustrating a detail of the clipping rendering optimization processing to be executed by the clipping rendering optimization processing unit 21 in step S602.

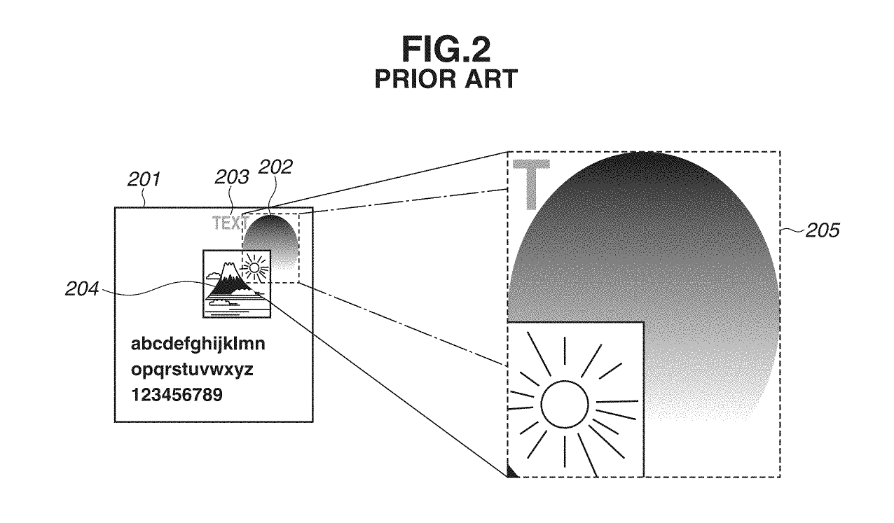

In step S700, if a rendering instruction (e.g., gradation rendering instruction) that cannot be processed by the printing apparatus 6 exists in the rendering instructions received from the layout processing unit 13, the clipping rendering optimization processing unit 21 detects the rendering instruction as a bitmapping target. Then, the clipping rendering optimization processing unit executes clipping rendering instruction conversion processing for converting the rendering instruction to a clipping rendering instruction by using the above technique described in FIGS. 2 and 3 (see United States Patent Application Publication No. 2014/0376055 A1). In other words, as illustrated in FIGS. 3G, 3I, and 3T, the rendering instruction is converted into a clipping rendering instruction described by the XAX method by using the rendering bitmap 205 (301, 303, 311, 313, 321, or 323) of a bitmapping target area and the mask bitmap 302, 312, or 322 of each attribute created based on the attribute of the pixel included in the bitmapping target area.

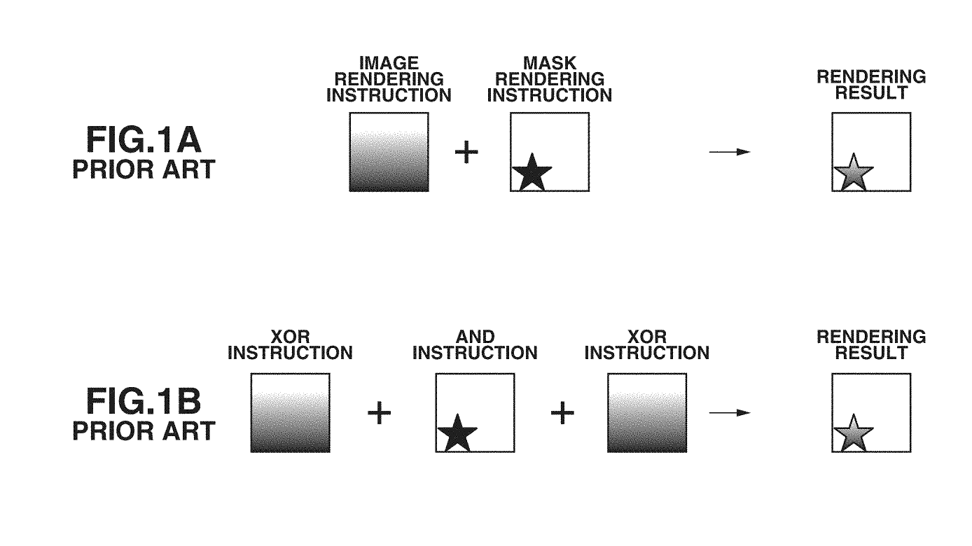

In addition, in the below-described exemplary embodiment, although a rendering instruction converted into a clipping rendering instruction described by the XAX method illustrated in FIGS. 3G, 3I, and 3T is taken as an example, a description method of the clipping rendering instruction is not limited to the XAX method. For example, the processing to be executed in steps S702 and S703 is also applicable to a clipping rendering instruction as illustrated in FIG. 1A, in which an image rendering instruction for rendering a rendering bitmap and a mask rendering instruction using a mask bitmap of each attribute are combined. Further, in the present exemplary embodiment, although a rendering instruction converted into a clipping rendering instruction in step S700 will be described as an example, the exemplary embodiment is not limited thereto. For example, there is a case where a rendering instruction output from a document creation application has already been described as a clipping rendering instruction. Further, in a case where the rendering instruction output from a document creation application is input to the printer driver 11 after being converted into a predetermined format through a conversion module of an OS, the rendering instruction may have already been converted into a clipping rendering instruction through the conversion module. For example, there is provided a conversion module of an OS such as the Microsoft XPS Document Converter (MXDC), and a rendering instruction output from a document creation application may be converted into a clipping rendering instruction through the above-described conversion module. Accordingly, if a rendering instruction received from the layout processing unit 13 has already been described as the clipping rendering instruction, the processing in step S700 may be skipped.

In step S701, the clipping rendering optimization processing unit 21 detects the rendering instruction about clipping rendering and executes the following processing in steps S702 and S703 every time the rendering instruction about clipping rendering is detected. In other words, if there is a rendering instruction about clipping rendering described by the XAX method as illustrated in FIGS. 3G, 3I, and 3T, the processing in the following steps S702 and S703 is executed with respect to the clipping rendering instruction. Here, the rendering instruction about clipping rendering includes the rendering bitmap 301, 303, 311, 313, 321, or 323 and the mask bitmap 302, 312, or 322 of each attribute generated based on the attribute bitmap illustrated in FIGS. 3G, 3I, and 3T.

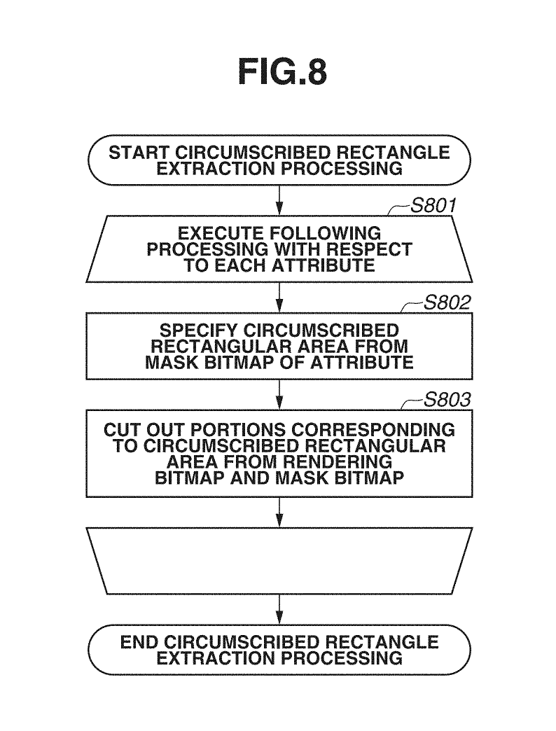

In step S702, the clipping rendering optimization processing unit 21 extracts a circumscribed rectangle of each attribute from the clipping rendering instruction as described below with reference to FIG. 8.

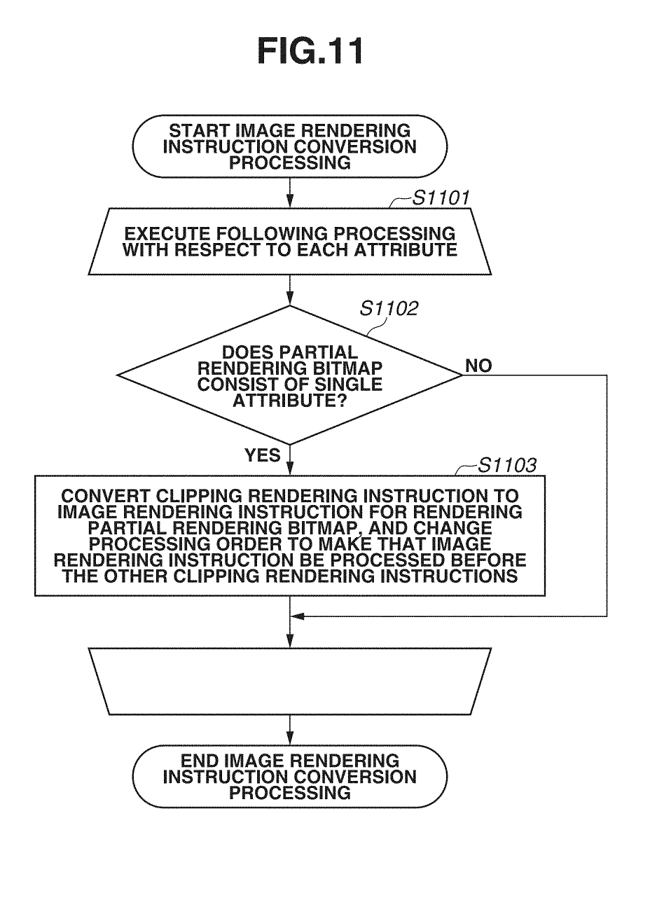

In step S703, based on the circumscribed rectangle of each attribute extracted in step S702, the clipping rendering optimization processing unit 21 executes image rendering instruction conversion processing as described below with reference to FIG. 11.

FIG. 8 is a flowchart illustrating a detail of the circumscribed rectangle extraction processing to be executed by the clipping rendering optimization processing unit 21 in step S702.

In step S801, based on the mask bitmap of each attribute (or attribute bitmap), the clipping rendering optimization processing unit 21 determines an attribute included in the clipping rendering instruction and repeatedly executes the following processing in steps S802 and S803 by making each attribute as a processing target.

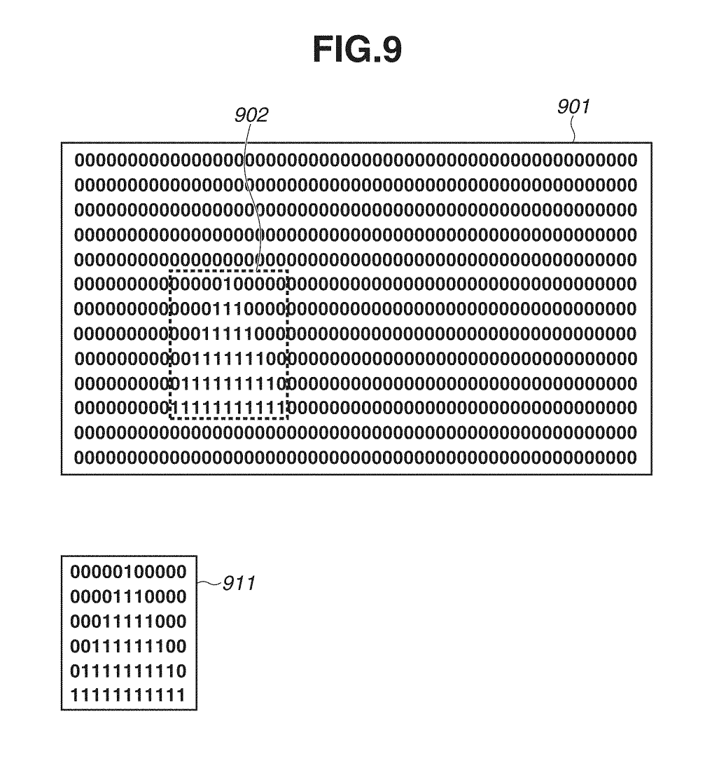

In step S802, based on the mask bitmap of the attribute currently detected as a processing target, the clipping rendering optimization processing unit 21 specifies a circumscribed rectangle area of the attribute. For example, FIG. 9 illustrates a mask bitmap 901 of one attribute. As illustrated in the mask bitmap 302, 312, or 322 in FIGS. 3G, 3I, and 3T, portions expressed by 1 in the mask bitmap 901 in FIG. 9 (i.e., a black portion in FIGS. 3G, 3I, and 3T) represent pixels to be clipped out from a clipping target image. The clipping rendering optimization processing unit 21 acquires a minimum circumscribed rectangle that surrounds portions of the pixels to be clipped out from the mask bitmap 901. In the mask bitmap 901 in FIG. 9, a circumscribed rectangle 902 that surrounds the portions expressed by 1 in the mask bitmap 901 is an area to be acquired in step S802. In the present exemplary embodiment, although a circumscribed rectangle is acquired based on the mask bitmap of an attribute as a processing target, the exemplary embodiment is not limited thereto. If there is an attribute bitmap indicating the attribute of each pixel of the rendering bitmap, the circumscribed rectangle may be determined based on the attribute bitmap.

In step S803, the clipping rendering optimization processing unit 21 cuts out portions corresponding to the circumscribed rectangular area acquired in step S802, i.e., a partial rendering bitmap and a partial mask bitmap, from the rendering bitmap and the mask bitmap of the attribute as a processing target. For example, if a portion corresponding to the circumscribed rectangle 902 is cut out from the mask bitmap 901 in FIG. 9, a partial mask bitmap 911 can be acquired. Thereafter, the rendering bitmap and the mask bitmap used for the clipping rendering instruction relating to the attribute as the processing target is replaced with the cutout partial rendering bitmap and the cutout partial mask bitmap.

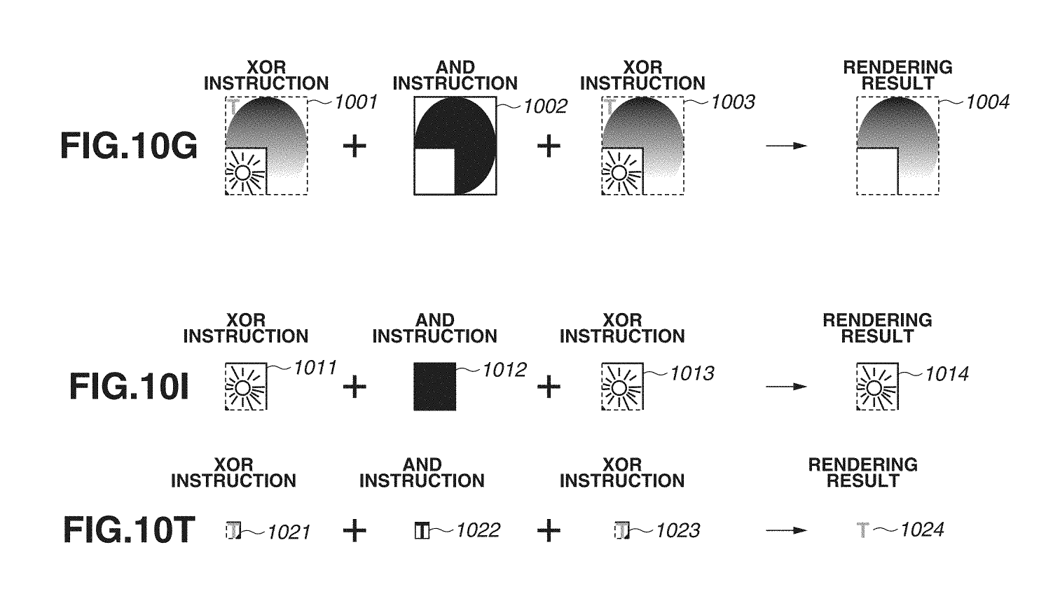

FIGS. 10G, 10I, and 10T are diagrams illustrating a clipping rendering instruction after applying the circumscribed rectangle extraction processing in FIG. 8 to the examples of the clipping rendering instruction in FIGS. 3G, 3I, and 3T. The bitmaps 301 to 324 in FIGS. 3G, 3I, and 3T respectively correspond to bitmaps 1001 to 1024 in FIGS. 10G, 10I, and 10T. In the examples in FIGS. 3G, 3I, and 3T, because a size of the circumscribed rectangle of the graphic attribute acquired in step S802 is the same as that of the mask bitmap as a processing target, the rendering bitmaps and the mask bitmap 1001 to 1003 used for the clipping rendering instruction of the graphic attribute in FIG. 10G are the same as the rendering bitmaps and the mask bitmap 301 to 303 used for the clipping rendering instruction thereof in FIG. 3G. On the other hand, in the example in FIGS. 3I and 3T, sizes of the circumscribed rectangles of the image attribute and the text attribute acquired in step S802 are smaller than those of the mask bitmaps as processing targets. Accordingly, the sizes of the partial rendering bitmaps 1011 and 1013 and the partial mask bitmap 1012 used for the clipping rendering instruction of the image attribute after applying the circumscribed rectangle extraction processing are smaller than the sizes of the rendering bitmaps 311 and 313 and the mask bitmap 312 before applying the circumscribed rectangle extraction processing. Further, the sizes of partial rendering bitmaps 1021 and 1023 and a partial mask bitmap 1022 used for the clipping rendering instruction of the text attribute after applying the circumscribed rectangle extraction processing are smaller than the sizes of the rendering bitmaps 321 and 323 and the mask bitmap 322 before applying the circumscribed rectangle extraction processing. With respect to the attribute (e.g., graphic attribute in FIGS. 10G, 10I, and 10T) whose mask bitmap (or rendering bitmap) has a size conforming to the size of the circumscribed rectangular area, the processing in step S803 may be skipped.

As described above, through the circumscribed rectangle extraction processing in FIG. 8, the rendering bitmap and the mask bitmap of each attribute used for the clipping rendering instruction in FIGS. 3G, 3I, and 3T are replaced with the partial rendering bitmap and the partial mask bitmap in FIGS. 10G, 10I, and 10T, so that the data size can be reduced.

FIG. 11 is a flowchart illustrating a detail of image rendering instruction conversion processing to be executed by the clipping rendering optimization processing unit 21 in step S703. A rendering instruction regarded as a processing target in FIG. 11 is a rendering instruction replaced with the clipping rendering instruction as illustrated in FIGS. 10G, 10I, and 10T through the circumscribed rectangle extraction processing in step S702.

In step S1101, based on the mask bitmap of each attribute (or attribute bitmap), the clipping rendering optimization processing unit 21 determines an attribute included in the clipping rendering instruction, and repeatedly executes the following processing in steps S1102 to S1103 by making each attribute as a processing targets.

In step S1102, the clipping rendering optimization processing unit 21 determines whether a partial rendering bitmap used for the clipping rendering instruction of a processing target attribute consists of a single attribute. If the partial rendering bitmap consists of a single attribute (YES in step S1102), the processing proceeds to step S1103. If a plurality of attributes is included in the partial rendering bitmap (NO in step S1102), the processing in step S1103 is skipped.

Whether the partial rendering bitmap consists of a single attribute can be determined by the following method. For example, the clipping rendering optimization processing unit 21 refers to the partial mask bitmap in FIGS. 10G, 10I, and 10T, and determines that the partial rendering bitmap used for the clipping rendering instruction of the processing target attribute consists of a single attribute if all of the portions in the partial mask bitmap of the processing target attribute are expressed by a value “1” (i.e., a black portion in FIGS. 10G, 10I, and 10T). Further, as another method, the clipping rendering optimization processing unit 21 may specify an area of a corresponding position in the attribute bitmap based on the area coordinates of the partial mask bitmap of the processing target attribute, and count the number of attributes included in the specified area in the attribute bitmap to determine whether the partial rendering bitmap consists of only a single attribute.

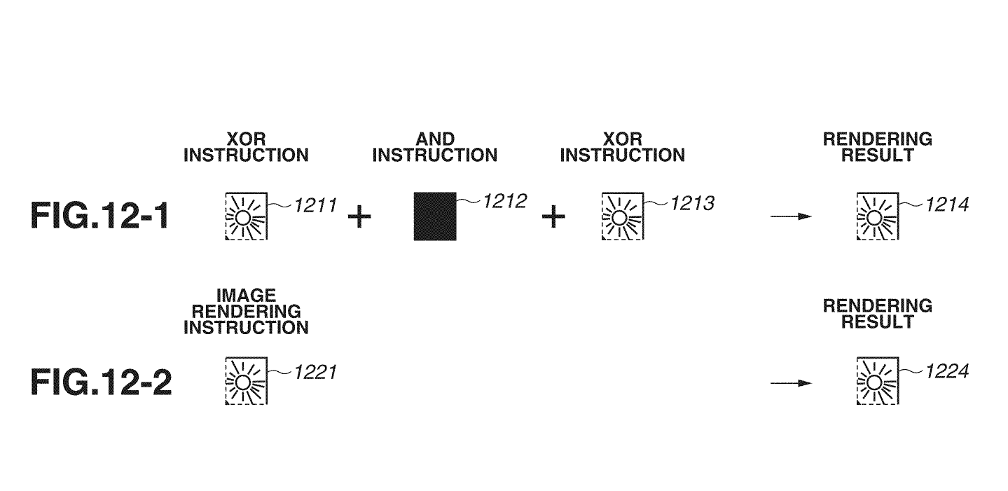

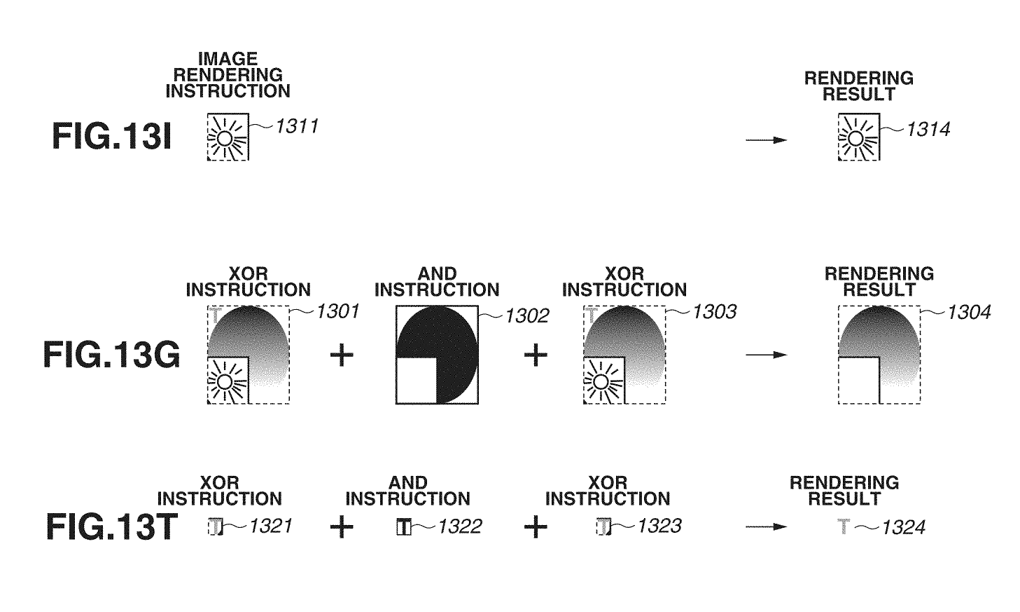

In step S1103, the clipping rendering optimization processing unit 21 converts the clipping rendering instruction of the attribute described by the XAX method into one image rendering instruction for rendering the partial rendering bitmap of the attribute. Further, the clipping rendering optimization processing unit 21 changes the order of image rendering instructions to make the converted image rendering instruction be executed before the other clipping rendering instructions of the other attributes. In the example in FIGS. 10G, 10I, and 10T, for example, because a partial mask bitmap consisting of a single attribute is only the mask bitmap 1012 of the image attribute, the processing in step S1103 is executed with respect to the clipping rendering instruction of the image attribute (i.e., rendering instruction group I in FIG. 101). Clipping rendering instructions 1211 to 1213 and a rendering result 1214 of a rendering instruction group 1 in FIG. 12-1 respectively correspond to the clipping rendering instructions 1011 to 1013 and the rendering result 1014 of the rendering instruction group I in FIG. 10I. If the processing in step S1103 is executed with respect to the clipping rendering instructions 1211 to 1213 of the rendering instruction group 1 in FIG. 12-1, the clipping rendering instructions 1211 to 1213 are converted into an image rendering instruction for rendering a partial rendering bitmap 1221 as illustrated in a rendering instruction group 2 in FIG. 12-2. When the rendering instruction groups 1 and 2 are compared to each other, it is found that a rendering result 1224 acquired by rendering the partial rendering bitmap 1221 is equivalent to the rendering result 1214 of the clipping rendering instructions 1211 to 1213. Then, if the order is changed to make the image rendering instruction be executed before the other clipping rendering instructions, the image rendering instruction of the image attribute is placed at the top of the order, so that the clipping rendering instruction group in FIGS. 10G, 10I, and 10T is changed as illustrated in FIGS. 13I, 13G and 13T. In FIGS. 13I, 13G, and 13T, the execution order is changed in such a manner that the image rendering instruction 1311 of the image attribute is first executed, and thereafter, the clipping rendering instructions 1301 to 1303 of the graphic attribute and the clipping rendering instructions 1321 to 1323 of the text attribute, on which the processing in step S1103 has not been executed, are executed.

Through the image rendering instruction conversion processing in FIG. 11, from among the clipping rendering instructions using the partial rendering bitmaps and the partial mask bitmaps illustrated in FIGS. 10G, 10I, and 10T, the clipping rendering instruction using the partial rendering bitmap consisting of a single attribute is replaced with the image rendering instruction for rendering the partial rendering bitmap as illustrated in FIGS. 13I, 13G, and 13T. Therefore, it is possible to further reduce the data size and the number of rendering instructions.

As described above, the clipping rendering optimization processing unit 21 of the printer driver 11 executes the circumscribed rectangle extraction processing in FIG. 8 with respect to the clipping rendering instruction to reduce a clipping rendering area which requires processing time, and further executes the image rendering instruction conversion processing in FIG. 11 to replace the clipping rendering instruction with the image rendering instruction that can be processed in a relatively short processing time. Therefore, it is possible to reduce the processing time.

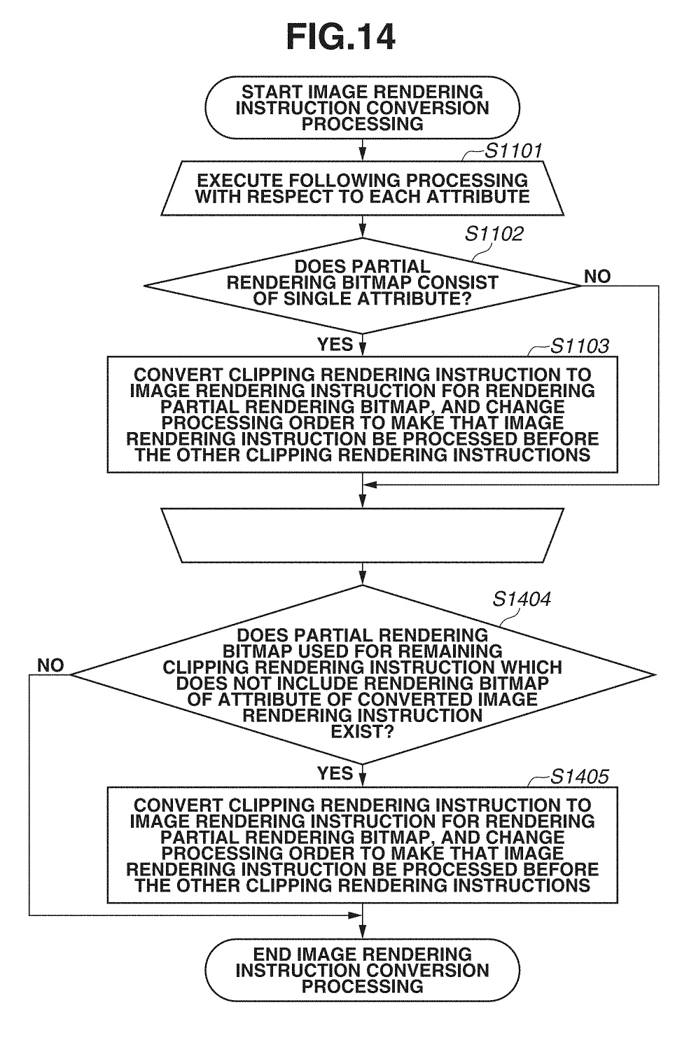

A second exemplary embodiment will be described. Another exemplary embodiment of the image rendering instruction conversion processing to be executed by the clipping rendering optimization processing unit 21 in FIG. 11 will be described with reference to a flowchart in FIG. 14. The processing other than the above is similar to the processing described in the first exemplary embodiment.

The processing in steps S1101 to S1103 in FIG. 14 is similar to the processing in steps S1101 to S1103 in FIG. 11. Accordingly, as described above, of the clipping rendering instructions in FIGS. 10G, 10I, and 10T, the clipping rendering instruction consisting of a single attribute is converted into the image rendering instruction at a point in time when the processing in step S1103 has been ended, so that the rendering instruction group is changed to a rendering instruction group as illustrated in FIGS. 13I, 13G, and 13T.

In step S1404, with respect to the partial rendering bitmaps used for the clipping rendering instructions remaining after the processing in steps S1101 to S1103, the clipping rendering optimization processing unit 21 determines whether any partial rendering bitmap which does not include the rendering bitmap of the attribute of the image rendering instruction converted in step S1103 exists. If the clipping rendering optimization processing unit 21 determines that the partial rendering bitmap which does not include the rendering bitmap exists (YES in step S1404), the processing proceeds to step S1405. If the clipping rendering optimization processing unit 21 determines that all of the partial rendering bitmaps used for the remaining clipping rendering instructions include at least a part of the rendering bitmap of the attribute of the image rendering instruction converted in step S1103 (NO in step S1404), the processing is ended.

In other words, in the example in FIGS. 13I, 13G, and 13T, the clipping rendering instructions of the graphic attribute and the text attribute are regarded as determination targets in step S1404. The partial rendering bitmap 1301 used for the clipping rendering instruction of the graphic attribute includes the rendering bitmap of the image attribute of the image rendering instruction converted in step S1103 at a lower left portion thereof. On the other hand, the partial rendering bitmap 1321 used for the clipping rendering instruction of the text attribute does not include any rendering bitmap of the image attribute of the image rendering instruction converted in step S1103, although a part of the rendering bitmap of the graphic attribute is included in the lower right portion thereof. Accordingly, the rendering bitmap used for the clipping rendering instruction of the text attribute does not include the rendering bitmap of the image attribute of the image rendering instruction converted in step S1103. Therefore, the processing proceeds to step S1405.

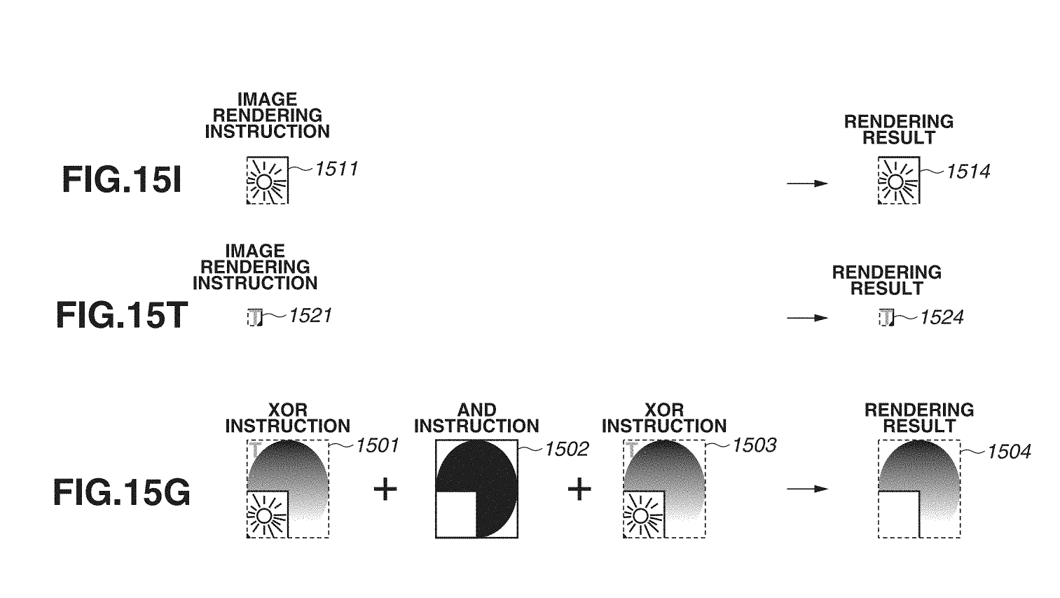

In step S1405, the clipping rendering optimization processing unit 21 converts the clipping rendering instruction which uses the rendering bitmap without including the rendering bitmap of the attribute of the converted image rendering instruction into the image rendering instruction for rendering the partial rendering bitmap, and changes the order to make that converted image rendering instruction be processed before the other clipping rendering instructions. In the example in FIGS. 13I, 13G, and 13T, the clipping rendering instruction of the text attribute is converted into the image rendering instruction for rendering the partial rendering bitmap. Then, the order is changed such that the converted image rendering instruction of the text attribute is processed before the clipping rendering instruction of the graphic attribute. As a result, the rendering instruction group in FIGS. 13I, 13G, and 13T is changed to the rendering instruction group illustrated in FIGS. 15I, 15T, and 15G.

In FIGS. 15I, 15T, and 15G, a partial rendering bitmap 1511 of the image attribute is first rendered by the image rendering instruction. Subsequently, a partial rendering bitmap 1521 of the text attribute is rendered by the image rendering instruction. Thereafter, the clipping rendering instruction of the graphic attribute is executed by the XAX method. Because a part of the rendering bitmap of the graphic attribute is included in the lower right portion of the partial rendering bitmap 1521 of the text attribute, the rendering bitmap of the graphic attribute is also included in the lower right portion of a rendering result 1524. However, because that portion is overwritten with the clipping rendering instruction of the graphic attribute to be subsequently executed, the image processing of the graphic attribute is eventually executed thereon.

Through the image rendering instruction conversion processing described in FIG. 14, a number of clipping rendering instructions replaced with the image rendering instructions is increased, so that the data size and the number of rendering instructions can be reduced further.

### Another Exemplary Embodiment

Further, the aspect of the embodiments can be realized by executing the following processing. In other words, software (program) for realizing the functions of the above-described exemplary embodiments is supplied to a system or an apparatus via a network or various storage media, so that a computer (or a CPU or a micro processing unit (MPU)) of the system or the apparatus reads and executes the program.

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-042044, filed Mar. 6, 2017, which is hereby incorporated by reference herein in its entirety.

What is claimed is:

1. An apparatus comprising:
a memory configured to store a computer program; and
at least one processor configured to execute the computer program to specify a circumscribed rectangular area of each attribute with respect to a clipping rendering instruction using a rendering bitmap and a mask bitmap of each attribute, to cut out a partial rendering bitmap of each attribute and a partial mask bitmap of each attribute corresponding to the circumscribed rectangular area from the rendering bitmap and the mask bitmap, and to replace the rendering bitmap and the mask bitmap used for the clipping rendering instruction with the cutout partial rendering bitmap and the cutout partial mask bitmap.

2. The apparatus according to claim 1, wherein the at least one processor further converts a clipping rendering instruction using a partial rendering bitmap consisting of a single attribute into an image rendering instruction for rendering the partial rendering bitmap consisting of the single attribute.

3. The apparatus according to claim 2, wherein the at least one processor further changes an order to make the converted image rendering instruction be processed before another clipping rendering instruction.

4. The apparatus according to claim 3, wherein the at least one processor further converts one clipping rendering instruction of an attribute which has not been converted into the image rendering instruction into an image rendering instruction for rendering a partial rendering bitmap and changes an order to make the image rendering instruction be processed before another clipping rendering instruction, if the partial rendering bitmap used for the one clipping rendering instruction does not include an attribute of a clipping rendering instruction that has been converted into the image rendering instruction.

5. The apparatus according to claim 1,
wherein the at least one processor further determines a rectangular area including a rendering instruction determined as a bitmapping target from among a plurality of rendering instructions, as a bitmapping target rectangular area and converts the rendering instruction included in the bitmapping target rectangular area into the clipping rendering instruction using the rendering bitmap and the mask bitmap of each attribute, and
wherein processing of specifying the circumscribed rectangular area of each attribute is executed with respect to the converted clipping rendering instruction.

6. The apparatus according to claim 1, wherein the clipping rendering instruction is a rendering instruction in which an XOR rendering instruction, an AND rendering instruction, and an XOR rendering instruction are combined.

7. The apparatus according to claim 1, wherein the clipping rendering instruction is a rendering instruction in which an image rendering instruction and a Mask rendering instruction are combined.

8. A non-transitory computer-readable storage medium storing a program for causing a computer to perform a method, the method comprising:
specifying a circumscribed rectangular area of each attribute with respect to a clipping rendering instruction using a rendering bitmap and a mask bitmap of each attribute;
cutting out a partial rendering bitmap of each attribute and a partial mask bitmap of each attribute corresponding to the circumscribed rectangular area from the rendering bitmap and the mask bitmap; and
replacing the rendering bitmap and the mask bitmap used for the clipping rendering instruction with the cutout partial rendering bitmap and the cutout partial mask bitmap.

9. The non-transitory computer-readable storage medium according to claim 8, further comprising converting a clipping rendering instruction using a partial rendering bitmap consisting of a single attribute into an image rendering instruction for rendering the partial rendering bitmap consisting of the single attribute.

10. The non-transitory computer-readable storage medium according to claim 9, further comprising changing an order to make the converted image rendering instruction be processed before another clipping rendering instruction.

11. The non-transitory computer-readable storage medium according to claim 10, further comprising converting one clipping rendering instruction of an attribute which has not been converted into the image rendering instruction into an image rendering instruction for rendering a partial rendering bitmap and changing an order to make the image rendering instruction be processed before another clipping rendering instruction, if the partial rendering bitmap used for the one clipping rendering instruction does not include an attribute of a clipping rendering instruction that has been converted into the image rendering instruction.

12. The non-transitory computer-readable storage medium according to claim 8, determining a rectangular area including a rendering instruction determined as a bitmapping target from among a plurality of rendering instructions, as a bitmapping target rectangular area, and converting the rendering instruction included in the bitmapping target rectangular area into the clipping rendering instruction using the rendering bitmap and the mask bitmap of each attribute, and
wherein processing of specifying the circumscribed rectangular area is executed with respect to the converted clipping rendering instruction.

13. The non-transitory computer-readable storage medium according to claim 8, wherein the clipping rendering instruction is a rendering instruction in which an XOR rendering instruction, an AND rendering instruction, and an XOR rendering instruction are combined.

14. The non-transitory computer-readable storage medium according to claim 8, wherein the clipping rendering instruction is a rendering instruction in which an image rendering instruction and a Mask rendering instruction are combined.

15. A method comprising:
specifying a circumscribed rectangular area of each attribute with respect to a clipping rendering instruction using a rendering bitmap and a mask bitmap of each attribute;
cutting out a partial rendering bitmap of each attribute and a partial mask bitmap of each attribute corresponding to the circumscribed rectangular area from the rendering bitmap and the mask bitmap; and
replacing the rendering bitmap and the mask bitmap used for the clipping rendering instruction with the cutout partial rendering bitmap and the cutout partial mask bitmap.

16. The method according to claim 15 further comprising converting a clipping rendering instruction using a partial rendering bitmap consisting of a single attribute into an image rendering instruction for rendering the partial rendering bitmap consisting of the single attribute.

17. The method according to claim 16 further comprising changing an order to make the converted image rendering instruction be processed before another clipping rendering instruction.

18. The method according to claim 17 further comprising converting one clipping rendering instruction of an attribute which has not been converted into the image rendering instruction into an image rendering instruction for rendering a partial rendering bitmap and changing an order to make the image rendering instruction be processed before another clipping rendering instruction, if the partial rendering bitmap used for the one clipping rendering instruction does not include an attribute of a clipping rendering instruction that has been converted into the image rendering instruction.

19. The method according to claim 15 further comprising:
determining a rectangular area including a rendering instruction determined as a bitmapping target from among a plurality of rendering instructions, as a bitmapping target rectangular area; and
converting the rendering instruction included in the bitmapping target rectangular area into the clipping rendering instruction using the rendering bitmap and the mask bitmap of each attribute,
wherein processing of specifying the circumscribed rectangular area is executed with respect to the converted clipping rendering instruction.
